(19) United States
(12) Patent Application Publication
(10) Pub. No.: US 2023/0349232 A1
(43) Pub. Date: Nov. 2, 2023

(54) RELEASABLE LOCKING MECHANISM

(71) Applicant: GALE PACIFIC LIMITED, Braeside, Victoria (AU)

(72) Inventors: Jeffrey Richard Turnbull, Denver, CO (US); Michael Ting, Altamonte Springs, FL (US)

(21) Appl. No.: 17/914,688

(22) PCT Filed: Mar. 15, 2021
(86) PCT No.: PCT/AU2021/050225

§ 371 Date: Sep. 26, 2022

(30) Foreign Application Priority Data
Apr. 7, 2020 (AU) 2020901082

(51) Int. Cl. E06B 9/78; E06B 9/90; A47H 5/02

(52) U.S. Cl. CPC E06B 9/78; E06B 9/90; A47H 5/02; E06B 2009/802

(57) ABSTRACT

A releasable locking mechanism comprising a lock mode, and an unlock mode; a handle and at least one resilient member mountable between the handle and a shaft, wherein the resilient member biases the mechanism to the lock mode when the mechanism is at rest; and actuation of the handle by a user releases the mechanism from the lock mode to the unlock mode, allowing rotation of the handle and the at least one resilient member about the shaft.

### CROSS REFERENCE TO RELATED APPLICATIONS

This application is a National Stage application of PCT/AU2021/050225, filed Mar. 15, 2021, which claims the benefit of Australian Application No. 2020901082, filed Apr. 7, 2020, both of which are incorporated by reference in their entirety herein

### TECHNICAL FIELD

The invention relates to a releasable locking mechanism to precisely position and prevent inadvertent rotation of appended items such as curtains, blinds, shades, shutters and privacy screens.

### BACKGROUND OF INVENTION

The following discussion of background art is included to explain the context of the present invention. A reference herein to a matter which is given as prior art is not to be taken as an admission that the matter was known or that the information it contains was part of the common general knowledge as at the priority date of any of the claims.

Curtain, blind, shading, screen and shutter assemblies are commonly used to provide shade, cover, privacy and/or security. They are applied to windows, openings in vehicles, buildings, outdoor features, and outdoor areas. They are also used in other facilities such as hospitals to provide people with privacy by establishing a zone in which others cannot see into.

There exists a variety of control systems to manipulate the position of curtains, blinds, shades, screens and shutters (hereinafter referred to as material/s) in said assemblies. Movement of material along a desired path is often achieved through a corded pulley system. The corded pulley system can additionally comprise a series of gears to translate vertical motion of a cord into rotation of a single or multiple shafts to which material is attached. With respect to blinds, a cord will be connected to a single or multiple pulleys which are linked to a shaft holding the blind material. When the cord is pulled clockwise or anti-clockwise a pulley, or a geared arrangement is rotated, resulting in movement of the shaft, and movement of the blind between an open and closed position. The position of the blind can be maintained using a variety of locating mechanisms, such as: counterweights in the pulley system; balled-chains with corresponding slots in the pulley system; or stops along a guide rail.

The reliance on corded systems has posed numerous problems. Cords are prone to entanglement, knotting and wear and tear. When cords fail, often the entire pully/gear system needs to be replaced. In addition to these functional limitations, cords can pose a safety risk as children and pets may seek to play with them. Where children and pets are able to reach the cords, they may knot the cords, or pull on the cords repeatedly, or entangle themselves in the cords which can cause serious injury. Additionally, the force of the pulling of the cords may result in an entire curtain system dislodging from its mounting whereby components or the entire system may fall from height.

There exist a number of solutions whereby cords are either concealed or are eliminated entirely. For example, winders may be used whereby the corded connection between the winder and the pulley system is concealed in a wall cavity. A winder protrudes from a wall to allow for movement of the cords within the wall cavity. Although the winder systems eliminate the risks and issues associated with exposed cords, they are prone to jamming, and wear and tear, and require regular maintenance. Due to the corded connection being concealed, repairs to such systems can be difficult, and may require complete removal of a curtain/blind system. In certain cases, portions of a wall may need to be removed to access damaged components. Additionally, winders often protrude outwards from a wall and pose a safety risk to people or animals passing by. In some more expensive assemblies, motors may be used to automate movement of a winder, which removes the need for an externally protruding manual winder

Alternatively, motors may be connected directly to a shaft to which material is appended, removing the need for a corded pulley system. In this respect, motors are attached to a shaft, or a geared system which actuates movement of a shaft without the need for cords. Despite motorisation eliminating many of the risks associated with exposed cords and winders, they are relatively more expensive than manually actuated systems, and require an electrical connection. Further, replacement and repairs of a motorised systems is expensive, and actuation of the system is difficult when power to the motor is not available due to a black out or a motor fault. Further, where it is not possible to run an electrical connection to a motor, motorisation is not a viable option.

There exist other cordless solutions such as the Litrise® solution or a spring loaded pre-tensioned shaft. Both involve the lowering of blinds by hand. The Litrise® blind is raised by hand whereby the blind does not rotate about a shaft. Rather, the blind folds in an expanding and contracting manner (in a concertina type arrangement), whereby an internal cord is pre-tensioned to keep the folded blind in place. This solution is not versatile as it can only be applied to a limited range of materials. Where large volumes of blind are used, or the blind material is thick, the Litrise® solution does not provide an aesthetically pleasing or viable solution.

Cordless blinds with spring loaded shafts are quite commonly used. A pre-tensioned spring biases a shaft to rotate in an anticlockwise direction or a clockwise direction. The shaft is locked in place by a spring-loaded knob which engages a corresponding retaining aperture when the shaft is rotated at low speeds, preventing the shaft from rotating further. As the knob is spring loaded it can be pushed out of the retaining aperture when sufficient force is applied, thus releasing the shaft for rotation. Material appended to the shaft can be raised by simply pulling downward on the material, to provide sufficient force to release the spring-loaded knob, which allows the shaft to rotate along with any appended material. A stop prevents the shaft from rotating any further. A stop can be a thickened part of the material, and usually comprises a rod running through the material to prevent rotation of the shaft. Pre-tensioned spring-loaded cordless blinds can be difficult to use. It can be challenging to precisely position a cordless blind. Further, the springs need to be re-tensioned regularly and are prone to wear. Additionally, the force of the pre-tensioned spring can result in a relatively violent movement of an appended blind if movement of the blind is not controlled. Such relatively violent movement could damage surrounding components, or dislodge the blind, or damage the blind.

It is therefore desirable to provide a releasable locking mechanism to prevent inadvertent rotation of appended items such as curtains, blinds, shades, shutters and privacy screens, whereby the position of the appended item can be adjusted safely, with precision, and with ease.

### SUMMARY OF INVENTION

According to one form of the invention there is provided a releasable locking mechanism comprising: a lock mode, and an unlock mode; a cordless handle to manually grip and actuate the mechanism, and at least one resilient member mountable between the handle and a shaft, wherein the resilient member biases the mechanism to the lock mode when the mechanism is at rest; and actuation of the handle by a user releases the mechanism from the lock mode to the unlock mode, allowing rotation of the handle and the at least one resilient member about the shaft. The mechanism provides a versatile system which can be manually actuated to safely and precisely adjust the positioning of appended items such as curtains, blinds, shades, shutters and privacy screens. The mechanism removes the need for cords to actuate movement of a shaft to adjust the positioning of appended materials.

In one aspect of the invention the handle is rotatable relative to the at least one resilient member in the lock mode, thus locking the position of any appended material at a user's desired location. In the unlock mode, any rotation of the handle and the at least one resilient member about the shaft is synchronous and allows for movement of appended material to a user's preferred position.

In the lock mode, the at least one resilient member exerts a compressive frictional force on the shaft to prevent rotation of the at least one resilient member relative to the shaft. Movement of the at least one resilient member against its lock mode bias reduces the compressive force of the resilient member on the shaft, placing the mechanism into the unlock mode. Due to the lock mode bias of the at least one resilient member, the mechanism remains in a lock mode when the handle is at rest (not actuated).

The at least one resilient member may be of any suitable material or configuration to exert an adequate compressive force on the shaft to prevent rotation in the lock mode. For example, the at least one resilient member may be a torsion spring, or a component such as a clamp, or a hose clamp. Further, the at least one resilient member may be a bulldog clip or bar bell spring collar.

In a further aspect of the invention a housing may be mounted to the handle to house the at least one resilient member and the shaft. The housing may be integral with the handle, or may be attachable to the handle. The housing may also be mountable to a headrail (or headrail insert) to which a material such as a blind is integral or appended to. The headrail may be one of a top or bottom headrail, or positionable anywhere between an upper most vertical or bottom most vertical position along a frame, wall or window. In this respect, the housing may be mountable to the headrail (or headrail insert) by a snap-fit arrangement, an interlocking arrangement, or may be attachable to the headrail by a rivet, or a screw or a nut and bolt arrangement, or chemically adhered. Alternatively, the housing may comprise a single or a plurality of ridges which may be received by corresponding grooves in the headrail. The housing may be used to protect internal components such as the at least one resilient member and the shaft and may further serve to locate and keep together any internal components of the releasable locking mechanism.

In a further aspect of the invention, the at least one resilient member may comprise at least two tabs wherein convergence of the at least two tabs releases the lock mode bias of the at least one resilient member. Specifically, the convergence of the at least two tabs reduces the compressive force of the at least one resilient member on the shaft. The convergence of the at least two tabs releases the resilient member and allows it to rotate about the shaft. According to this aspect of the invention, actuation of the handle results in the convergence of the least two tabs, placing the mechanism into the unlock mode.

According to the above aspect of the invention the handle may comprise an extension surrounding the at least one resilient member. The extension may comprise an aperture adequately sized to receive the at least two tabs of the at least one resilient member when in the lock mode, and to convergently move the at least two tabs when the handle and the extension are rotated to place the mechanism in the unlock mode. The extension may be tubular in form. Alternatively, the handle may comprise two separate members extending from the handle to the at least two tabs of the at least one resilient member, and adequately spaced apart to receive the two tabs when the mechanism is in the lock mode, and to convergently move the at least two tabs when the handle and the extension are rotated to move the mechanism in to the unlock mode.

In a further alternative aspect of the invention, inward or outward movement of the handle in a longitudinal direction along a central horizontal axis of the mechanism may result in the movement of the at least one resilient member against the lock mode bias and place the mechanism in the unlock mode.

According to the above aspects of the invention, the handle may comprise at least one actuating arm protruding radially outward form a horizontal axis of rotation. This allows a user to easily grip and rotate the handle to precisely position material appended to a headrail. In a preferred aspect, the handle may comprise six radially extending arms. The arms may be uniformly spaced about the horizontal axis of rotation. The uniformly spaced arms will allow a user to place their fingers in between the handle arms to grip and to rotate the handle with ease.

The handle may comprise an aperture for receiving the shaft. The shaft may comprise an aperture for receiving a bracket mount. This allows an assembly comprising the releasable locking mechanism to be mounted to a wall or vertical support such as a pole. The mount may be configured to be relatively slim to maximise contact between a user's hand and the handle. In an alternative aspect, the mount may be configured to receive a portion of the mechanism on the internal side of the handle, whereby the mount does not obstruct contact between a user's hand and the handle. In this respect, rotation of the mechanism will occur relative to a mount, as the mount will remain stationary.

In a further aspect, the mechanism may comprise an extension apparatus to actuate and/or rotate the handle. This allows for actuation and movement of the handle from a practical and safe position in situations where the handle is not easily reachable.

According to another embodiment of the invention, there is provided a blind assembly comprising the releasable locking mechanism according to the above-mentioned embodiment and aspects, wherein movement of blind material is controlled by the releasable locking mechanism. The assembly is not restricted to a blind assembly, and may be a curtain assembly, a shutter assembly, a privacy screen assembly, an outdoor area shade assembly, or any other assembly requiring material to be safely and precisely moved and positioned. Further, the assembly may comprise a guide to direct movement of blind material. The guide may have a vertical upper edge limit and a vertical lower edge limit, and the mechanism may be mounted at or proximate the upper edge limit, or at or proximate the lower edge limit, or at any point between the upper or lower edge limit.

The versatility of the releasable locking mechanism and the assembly noted above allows the mechanism to be appended to a variety of materials, manufactured and tailored to different environments, being indoors, outdoors, or environments subject to extreme heat or cold. The mechanism may be retrofitted to headrails currently operated by pulley-based systems, or to a pre-tensioned spring loaded mechanism. In this respect, the mechanism may form part of a kit comprising a series of adaptors to allow the mechanism to be fitted or appended to differently sized rails to which material is attached.

Further, the mechanism may be made of any number of materials. In one aspect, the mechanism may be made of a plastic, such as acrylonitrile butadiene styrene (ABS), HDPE, or any other plastic considered appropriate for the environment in which the device is to be used.

In an alternative aspect, the device may be made of a metal or an alloy. In yet another aspect, the device may be made up of a combination of plastic, and/or a metal, and/or an alloy. Further, components prone to wear such as the handle, and each resilient member, may comprise heavy duty materials resistant to wear. Further, the components of the mechanism may be designed to be replaceable.

In a further alternative aspect, the handle may comprise a geared system to reduce the force required to rotate the handle. Alternatively, rotation of the handle may be automated, through the use of a motor, particularly where material appended to an assembly is excessively heavy.

The releasable locking mechanism provides a versatile system which can be manually actuated to safely and precisely adjust the positioning of appended items such as curtains, blinds, shades, shutters and privacy screens. The mechanism removes the need for cords to actuate movement or to adjust the positioning of appended materials. The simplicity of the design of the mechanism provides a neat, safe, low cost, low maintenance and versatile solution in comparison to the prior art solutions. The mechanism can be designed to be easily retrofitted to pre-installed headrails to which material is already appended.

Where the terms “comprise, “comprises”, “comprised” or “comprising” are used in this specification (including the claims) they are to be interpreted as specifying the presence of the stated features, integers, steps or components, but not precluding the presence of one or more other features, integers, steps or components, or group thereto.

### BRIEF DESCRIPTION OF DRAWINGS

It will be convenient to hereinafter describe preferred embodiments of the invention with reference to the accompanying figures. The particularity of the figures is to be understood as not limiting the preceding broad description of the invention.

FIG. 1 shows a perspective view of an embodiment of the releasable locking mechanism as assembled;

FIG. 2 shows a perspective view of the releasable locking mechanism of FIG. 1 without the housing installed;

FIG. 3 shows a perspective view of the releasable locking mechanism of FIG. 1 with the housing superimposed;

FIG. 4 separately shows the handle, the shaft, a resilient member, and the housing of the releasable locking mechanism of FIG. 1;

FIG. 5 shows two perspective views of the releasable locking mechanism of FIG. 1 with a headrail attached;

FIG. 6 shows the releasable locking mechanism of FIG. 5 attached to a mounting bracket; and

FIG. 7 shows the releasable locking mechanism of FIG. 5 attached to a slim mounting bracket.

### DETAILED DESCRIPTION

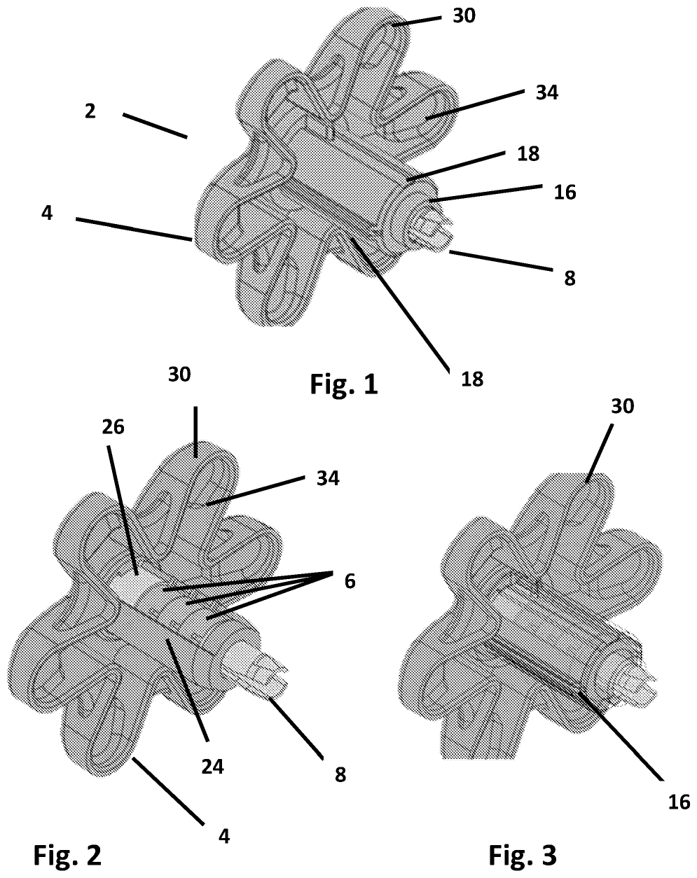

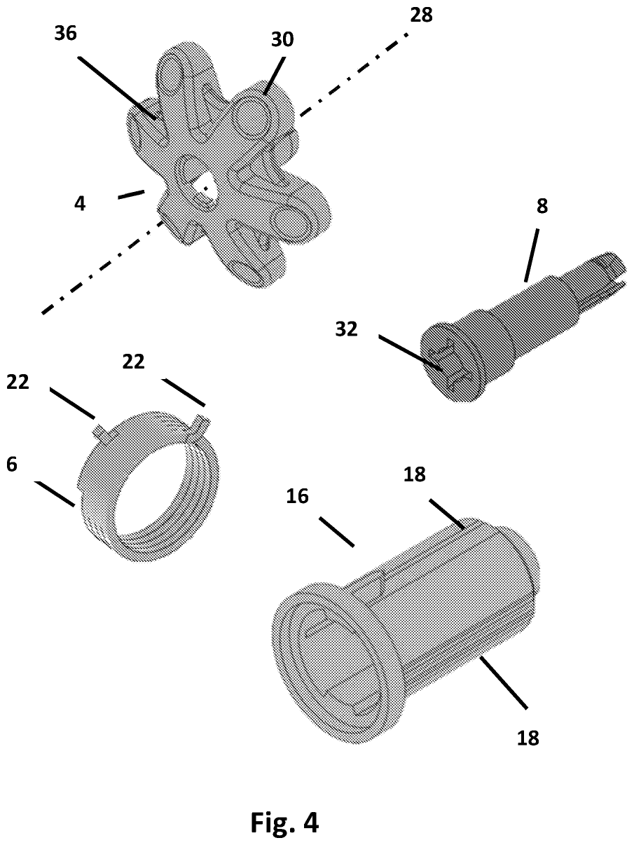

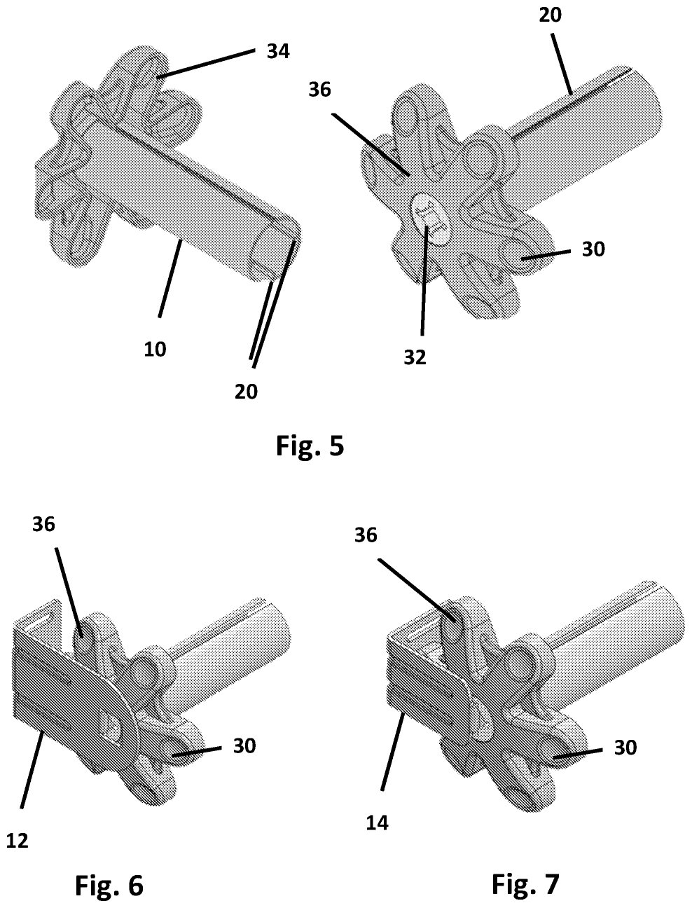

FIG. 1 shows an embodiment of the releasable locking mechanism 2 without a headrail 10 attached. FIGS. 2 shows the mechanism 2 of FIG. 1 with a housing 16 removed. FIG. 3 shows the mechanism 2 with the housing 16 superimposed. FIG. 4 individually shows a handle 4, a resilient member 6, a shaft 8 and a housing 16, all of which form part of the mechanism 2 of FIGS. 1 to 3 and 5 to 7. FIG. 5 shows the releasable locking mechanism 2 of FIGS. 1 to 3 with a headrail 10 attached. FIGS. 6 and 7 show the mechanism 2 of FIGS. 1 to 4, and 5 to 7 attached to mounting brackets 12 and 14.

The releasable locking mechanism 2 as seem in FIGS. 1 to 3 and 5 to 7 has a lock mode, and an unlock mode. The mechanism 2 is designed to remain in a lock mode when at rest.

The mechanism 2 comprises a handle 4 and at least one resilient member 6 mountable between the handle 4 and a shaft 8. In the embodiment of FIGS. 1 to 7, each resilient member 6 is a torsion spring 6. As shown in FIGS. 2 and 3, the mechanism comprises three torsion springs 6 which bias the mechanism 2 to the lock mode when the mechanism 2 is at rest.

Actuation of the handle 4, by a user, releases the mechanism 2 from the lock mode to the unlock mode, allowing rotation of the handle 4 and each resilient member 6 about the shaft 8. Rotation of the handle 4 and each spring 6 results in rotation of a headrail 10 to which material (not shown in the drawings) may be appended.

In the lock mode, each resilient member 6 is biased to exert a compressive frictional force on to the shaft 8. It biases the mechanism 2 into a lock mode. The compressive frictional force prevents rotation of each resilient member 6 about the shaft 8. As shown in FIGS. 2 and 3, there are three torsion springs 6 exerting this compressive frictional force on to the shaft 8. The mechanism 2 is not limited to having 3 springs, and the number of springs 6 used can vary from a single spring, or any suitable resilient member, to as many springs or resilient members that are required to exert an adequate compressive force on the shaft to bias the mechanism to a lock mode. A factor in determining the type and number of resilient members 6 required is the type and weight of material that the mechanism 2 is required to rotate.

The at least one resilient member 6 may be of any suitable material or configuration, or combination, to exert an adequate compressive force on the shaft in the lock mode to prevent rotation of a headrail 10 having material appended. For example, the at least one resilient member 6 may be a torsion spring as shown in FIGS. 2 and 3, or a component such as a clamp, or a hose clamp, or a combination of springs and clamps or any other suitable components, or components known to operate in a similar manner to a torsion spring. For example, the at least one resilient member 6 may be a bulldog clip or a bar bell spring collar.

In the lock mode, the handle 4 is rotatable about the shaft 8 relative to each spring 6. That is, each spring 6 does not rotate about the shaft 8 in the lock mode. Slight movement or rotation of the handle 4 in the lock mode will not result in movement of the mechanism 2 to an unlock mode, giving the mechanism 2 a stable mode of operation.

Movement of each resilient member 6 against its lock mode bias reduces the compressive force of the resilient member 6 on the shaft 8, placing the mechanism into the unlock mode. As each resilient member 6 is biased to the lock mode, releasing of the handle by the user places the mechanism back into the lock mode. In the embodiment shown in FIGS. 1 to 3 and 5 to 7, when the mechanism 2 is in the unlock mode, rotation of the handle 4 and each resilient member 6 about the shaft 8 is synchronous. With this synchronous movement, material appended to the mechanism 2 can be moved to a user's preferred position.

In FIGS. 1 to 4 a housing 16 is shown. The housing 16 is mounted to the handle 4 and houses the three torsion springs 6 and the shaft 8. Although the drawings only show the housing 16 attached to the handle 4, the housing 16 may be integral with the handle 4 or may be attachable to the handle 4. In this respect, the housing 16 rotates with the handle 4. Where the housing 16 is integral with the handle 4, a locating screw or a fastener (not shown in the drawings) attachable to the end of the shaft 8 may be used to keep the shaft 8 and the at least one resilient member 6 in the housing. Where the housing 16 is not integral with the handle 4, the housing 16 may be attachable to the handle 4 by a screw-and-thread arrangement, or a snap fit arrangement, or an interlocking arrangement, or the housing 16 may be chemically adhered to the handle 4.

The housing 16 protects the internal components of the mechanism 2 such as the at least one resilient member 6 of the mechanism 2, and the shaft 8. The housing 16 further serves to locate and keep together the internal components of the releasable locking mechanism 2.

In FIG. 5 the housing 16 is mountable to a headrail 10 to which a material such as a blind may be appended. The housing 16 comprises a plurality of mounting ridges 18 (see FIG. 1) which are designed to be received by corresponding grooves 20 of the headrail 10.

In alternative embodiments not shown in the drawings, the housing 16 may be mountable to the headrail 10 by a snap-fit arrangement, an interlocking arrangement, or may be attachable to the headrail 10 by a rivet, or a screw, or a nut and bolt arrangement, or may be chemically adhered to the headrail 10.

As shown in FIG. 4, the resilient member 6 is a torsion spring 6, which comprises two tabs 22. The convergence of the two tabs 22 releases the lock mode bias of the resilient member 6. The convergence of the two tabs 22 results in the diameter of the spring 6 increasing, which reduces the compressive frictional force of the spring 6 on to the shaft 8. The reduction of frictional force releases the spring 6 from the shaft 8, and allows the spring 6 to rotate about the shaft 8 in the unlock mode. When the two tabs 22 are at rest, or released from the converging force, the lock mode bias of the spring 6 reduces the diameter of the spring 6 which exerts a frictional force on the shaft 8 to prevent rotation of the spring about the shaft 8.

According to the embodiment of the mechanism 2 shown in the drawings, actuation of the handle 4 results in the convergence of the two tabs 22 of the springs 6, placing the mechanism 2 into the unlock mode. As shown in FIG. 2 the handle 4 comprises an extension 24 surrounding each spring 6. The extension 24 comprises an aperture 26 sized to receive the two tabs 22 of each spring 6 when in the lock mode. When the handle 4 is rotated, the extension 24 rotates. When rotating, the extension 24 convergently moves the two tabs 22 of each spring 6. The convergent movement of the two tabs 22 of each spring 6 places the mechanism 2 in the unlock mode.

In an alternative embodiment not shown in the drawings, the extension 24 of the handle 4 is not tubular and may comprise of two separate extension members extending from the handle 4 to the two tabs 22 of each resilient member 6. These members may be integral with or attachable to the handle 4 and need only be able to rotate synchronously with the handle 4. The extension members are to be adequately spaced apart to receive the two tabs 22 when the mechanism is in the lock mode, and to convergently move the two tabs 22 when the handle 4 is rotated to place the mechanism in to the unlock mode.

As indicated in FIG. 4, the handle 4 comprises at least one actuating arm 30 protruding radially outward form a horizontal axis of rotation. The handle 4 shown in the drawings comprises six arms 30 spaced uniformly about a horizontal axis of rotation 28. A user is able to place at least one finger in between each arm 30 to grip and rotate the handle 4 with ease. Although various alternative embodiments of the handle 4 are not shown in the drawings, handle 4 is able to take the form of any design or configuration which will allow a user to easily grip and rotate the handle 4 to precisely position material appended to a head rail 10.

In a further alternative embodiment not shown in the drawings, an extension apparatus may be attached to the handle 4 to allow the handle 4 to be actuated and/or rotated. The extension apparatus may be used to actuate the handle 4 in the event the handle 4 is not reachable by hand or may allow for actuation and rotation from a more practical position. The apparatus may be an extension arm. The extension arm may simply be a rod attached to an outer edge of the handle 4 whereby movement of the rod in a circular motion about a horizontal axis results in the actuation and movement of the handle 4. Alternatively, the extension arm, such as a rod, may be connected to the handle 4 in a bevel gear arrangement, whereby rotation of the extension arm about a vertical axis results in movement of the handle 4. Alternatively, the extension arm may comprise several interconnected components through, for example, a bevel gear arrangement. The bevel gear arrangement allows for the translation of rotational movement of a component attached to the arm to actuate the handle 4. Further, the extension arm may be detachable, extendible and retractable.

In a further alternative embodiment not shown in the drawings, the handle 4 may comprise a geared system to reduce the force required to rotate the handle 4. Alternatively, the mechanism 2 may comprise a pre-tensioned spring to reduce the force required by a user to rotate the handle 4. Alternatively, rotation of the handle 4 may be automated using a motor, particularly where material appended to the mechanism 2 is relatively heavy and manual rotation of the handle 4 requires excessive force.

As can be seen in FIGS. 1 to 7 the handle 4 comprises an aperture to receive the shaft 8. The handle 4 is designed to rotate about the shaft 8. The shaft 8 comprises an aperture 32 for receiving a bracket mount 12 or 14. This enables the mechanism 2 to be mounted to a wall or vertical supports such as a pole (not shown in the drawings).

A commonly used mount 12 is shown in FIG. 6. FIG. 7 shows a customised mount 14 tailored for use with the releasable locking mechanism 2 shown in FIGS. 1 to 3, 5 and 6. Mount 14 is configured to be slimmer than mount 12 to allow for a larger area of contact between a user's hand and the handle 4.

In an alternative embodiment not shown in the drawings, the mount may be configured to attach to the mechanism 2 on the internal side 34 of the handle 4. In this respect, the mechanism 2 will rest on a mounting arm, and will rotate within the confines of the arm, whereby the arm remains stationary. This configuration will not obstruct a user's hand from contacting the outer side 36 of the handle 4.

In a further alternative embodiment of the invention not shown in the drawings, inward or outward movement of the handle 4 in a longitudinal direction along a central horizontal axis 28 of the mechanism 2 may result in the movement of each resilient member against the lock mode bias. Such movement will be able to place the mechanism 2 in to the unlock mode. In this alternative embodiment, compression of each resilient member 6 along the horizontal axis 28 will reduce or release the compressive frictional force of each resilient member onto the shaft 8, and allow for rotation of each resilient member 6.

Although not shown in the drawings, a packaged blind assembly comprising the releasable locking mechanism 2 shown in FIGS. 1 to 7, or alternative embodiments described in the preceding paragraphs may be provided. In the packaged blind assembly, movement of blind material is controlled by the releasable locking mechanism 2. It is noted that the mechanism 2 is not restricted to forming part of a blind assembly, and may come as part of a curtain assembly, a shutter assembly, a privacy screen assembly, an outdoor area shade assembly, or any other assembly requiring material to be safely and precisely positioned along a generally vertical path. Alternatively, the mechanism 2 may be retrofitted to existing assemblies.

In a further alternative embodiment of the invention not shown in the drawings, the assembly may comprise a guide to direct the movement of any material appended to the mechanism 2. The guide may be a frame, or a single vertical guide, or two vertical tracks arranged at opposite ends in a horizontal direction of the mechanism 2, within which the outer edges of any material appended to the mechanism 2 are enclosed. The guide may comprise an upper edge, being the maximum vertical height of the guide, and a lower edge being the lowest vertical point of the guide. The mechanism 2 may be positioned anywhere between the upper and the lower edge of the guide. Further, the mechanism may be moveable and locked in place anywhere between the upper and lower edge of the guide.

In a further embodiment of the invention not shown in the drawings the headrail 10 of the mechanism 2 may comprise a central shaft, and/or an upper shaft, and or a lower shaft, whereby the shafts are in rotational connection with each other. The rotational connection between the shafts may be facilitated by interlocking gears of the shafts, or a belt drive connection, whereby rotation of the handle 4 results in the rotation of the central shaft and any additional shafts the mechanism 2 may comprise. Material may be appended to each of the shafts, whereby rotation of the central shaft will result in the movement of material appended to any of the shafts. Further, the shafts may comprise a disengagement mechanism similar to a clutch, which when engaged, allows for one of the shafts to remain stationary whilst another shaft rotates.

In a further embodiment to that described in the above paragraph, material may be appended to an upper and a lower shaft. In this embodiment rotation of the handle 4 results in movement of the material appended to the upper shaft along a guide, and movement of the material appended to the lower shaft along a guide. The guides may allow for simultaneous movement of material in an upward and/or downward direction. The appended material may be the same material, or contain different properties, where for example one material may be translucent, and the other material may be opaque.

The components of the mechanism 2 may be made of any number of materials. They may be made of a plastic, such as acrylonitrile butadiene styrene (ABS), HDPE, or any other plastic considered appropriate for the environment in which the device is to be used. Further, components of the mechanism 2 may be made of a metal or an alloy or of a combination of plastic, and/or a metal, and/or an alloy. Components prone to wear such as the handle 4 and each resilient member 6 may comprise heavy duty materials resistant to wear. Further, the mechanism 2 may be designed in such a way that all components, or those prone to wear are replaceable.

The versatility of the releasable locking mechanism 2 allows the mechanism 2 to be manufactured in different materials and tailored to a variety of operation environments, being indoors, outdoors, or environments subject to extreme heat or cold. The mechanism 2 may come as part of an assembly, or may be retrofitted to headrails currently operated by pulley-based systems, or to a pre-tensioned spring loaded mechanism. The mechanism 2 may form part of a kit comprising a series of adaptors to allow the mechanism 2 to be fitted to, or appended to rails of different sizes.

The releasable locking mechanism 2 provides a versatile system which can be manually actuated to safely and precisely adjust the positioning of appended items such as curtains, blinds, shades, shutters and privacy screens. The mechanism 2 removes the need for cords in a blind assembly, or a curtain assembly, or a shutter assembly, or a privacy screen assembly, or an outdoor area shade assembly, or any other assembly requiring material to be safely and precisely positioned along a generally vertical path. The simplicity of the design of the mechanism provides a neat, safe, low cost, low maintenance and versatile solution in comparison to the prior art solutions, whereby the mechanism can be designed to be easily retrofitted to pre-installed headrails to which material is already appended.

It is to be understood that various alterations, modifications and/or additions may be introduced into the construction and arrangement of the parts previously described without departing from the spirit or ambit of this invention.

### LIST OF REFERENCE NUMERALS

2-Releasable locking mechanism
4-Handle
6-Resilient member
8-Shaft
10-Headrail
12-Mounting Bracket
14-Slim Mounting Bracket
16-Housing
18-Ridges
20-Groove
22-Resilient member tabs
24-Handle Extension
26-Handle Extension Aperture
28-Horizontal Axis of Rotation
30-Handle Arms
32-Bracket Mount Aperture
34-Internal Side of the Handle 4
36-Outer side of the Handle 4

1. A releasable locking mechanism comprising:
a lock mode, and an unlock mode;
a cordless handle to manually grip and actuate the mechanism, and at least one resilient member mountable between the handle and a shaft, wherein
the resilient member biases the mechanism to the lock mode when the mechanism is at rest;
and actuation of the handle by a user releases the mechanism from the lock mode to the unlock mode, allowing rotation of the handle and the at least one resilient member about the shaft.

2. The mechanism according to claim 1, wherein the handle is rotatable relative to the at least one resilient member in the lock mode, and in the unlock mode any rotation of the handle and the at least one resilient member about the shaft is synchronous.

3. The mechanism according to claim 1, when in the lock mode, the at least one resilient member exerts a compressive frictional force on the shaft to prevent rotation of the at least one resilient member relative to the shaft.

4. The mechanism according to claim 1, wherein the at least one resilient member is a torsion spring.

5. The mechanism according to claim 4, wherein movement of the at least one resilient member against its lock mode bias reduces the compressive force of the resilient member on the shaft, placing the mechanism in the unlock mode.

6. The mechanism according to claim 1, wherein a housing is mounted to the handle to house the at least one resilient member and the shaft.

7. The mechanism according to claim 6, wherein the housing is integral with the handle.

8. The mechanism according to claim 6, wherein the housing is mountable to a headrail or headrail insert, wherein the headrail is one of a top or bottom headrail, or the headrail is positioned anywhere between an upper most vertical or bottom most vertical position along a frame, wall or window.

9. The mechanism according to claim 8, wherein the housing is mountable to the headrail or headrail insert by a snap-fit arrangement.

10. The mechanism according to claim 8, wherein material is appended to, or is integral with a headrail.

11. The mechanism according to claim 1, wherein the at least one resilient member comprises at least two tabs wherein convergence of the at least two tabs releases the lock mode bias of the at least one resilient member.

12. The mechanism according to claim 11, wherein actuation of the handle results in the convergence of the least two tabs, placing the mechanism in the unlock mode.

13. The mechanism according to claim 12, wherein the handle comprises an extension surrounding the at least one resilient member, wherein the extension comprises an aperture sized to receive the at least two tabs when in the lock mode, and to convergently move the at least two tabs when the handle and the extension are rotated to place the mechanism in the unlock mode.

14. The mechanism according to claim 1, wherein inward or outward movement of the handle in a longitudinal direction along a central horizontal axis of the mechanism results in the movement of the at least one resilient member against the lock mode bias, placing the mechanism in the unlock mode.

15. The mechanism according to claim 1, wherein the handle comprises at least one actuating arm protruding radially outward form a horizontal axis of rotation.

16. The mechanism according to claim 14 wherein the handle comprises six radially extending arms, wherein the arms are uniformly spaced about the horizontal axis of rotation.

17. The mechanism according to claim 1 wherein the handle comprises an aperture for receiving the shaft, and the shaft comprises an aperture for receiving a bracket mount.

18. The mechanism according to claim 1 wherein an exterior mount is configured to receive and support a section of the shaft on an internal side of the handle.

19. The mechanism according to claim 1, wherein the at least one resilient member is a clamp, or a bulldog clip.

20. The mechanism according to claim 1, comprising an extension apparatus to actuate and/or rotate the handle.

21. A kit comprising adaptors and a mechanism according to claim 1, wherein the adaptors are used to retrofit the mechanism to headrails.

22. An assembly comprising a releasable locking mechanism according to claim 1, wherein movement of the material is controlled by the releasable locking mechanism.

23. The assembly of claim 22, comprising a guide having a vertical upper edge limit and a vertical lower edge limit, wherein the mechanism is mounted at or proximate the upper edge limit, or at or proximate the lower edge limit, or at any point between the upper or lower edge limit.
